(19) United States
(12) Patent Application Publication
(10) Pub. No.: US 2026/0022247 A1
(43) Pub. Date: Jan. 22, 2026

(54) LOW VOC IONIC SOLVENTS AS DYE CARRIERS FOR ARAMID FIBERS

(71) Applicant: Dow Global Technologies LLC, Midland, MI (US)

(72) Inventors: Felipe A. Donate, Midland, MI (US); Rebecca J. Wachowicz, Bay City, MI (US); Matthew W. Entorf, Midland, MI (US)

(21) Appl. No.: 18/875,369

(22) PCT Filed: Jul. 28, 2022
(86) PCT No.: PCT/US2022/038649

§ 371 Date: Dec. 16, 2024

(51) Int. Cl. C09B 67/20; D06P 1/41; D06P 1/66; D06P 3/24; D06P 5/20

(52) U.S. Cl. CPC C09B 67/0065; D06P 3/242; D06P 5/2066; D06P 1/41; D06P 1/66

(57) ABSTRACT

Compositions and methods for dyeing aramids include one or more dye carriers selected from dialkyl imidazolium salts having a cation of the general formula: where R₁ and R₂ are, independently, selected from C1 to C8 alkyl, and bis-quaternary amine salts having a cation of the formula: where R₁ is, independently at each instance, a C1-C6 alkyl; R₂ and R₃ are, independently at each instance, a C1-C6 alkyl or substituted C1-C6 alkyl, and X is, independently at each instance, a halogen; and one or more cationic dyes.

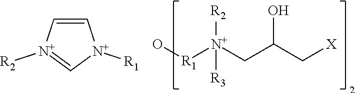

### FIELD

Embodiments relate to non-volatile dye carriers for dyeing and processing aromatic polyamides, and methods of dyeing aramid fibers and textiles.

### INTRODUCTION

Aromatic polyamides (aramids) in the form of fibers produce textile materials and articles that are durable, highly resistant to chemical agents, and stable at high temperatures (fire resistant). As compared to typical textiles, aramids are hydrophobic and difficult to dye, as standard aqueous dye formulations are unable to penetrate into the material. In a typical aramid fiber dyeing operation, aramid textiles and fibers are treated in pressurized dyeing equipment with an aqueous dye solution containing a dye carrier that swells constituent fibers. The dye carrier facilitates penetration of the dye throughout the aramid fibers and enhances color and color retention. Solvents such as acetophenone were once ubiquitous in industrial processes as dye carriers, but the high vapor pressure and concerns over odor and toxicity has led to interest in alternatives having reduced volatile organic compound (VOC) emissions.

### SUMMARY

Compositions for dyeing aramids include: one or more dye carriers selected from dialkyl imidazolium salts having a cation of the general formula:

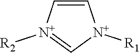

where R₁ and R₂ are, independently, selected from C1 to C8 alkyl, and bis-quaternary amine salts having a cation of the formula:

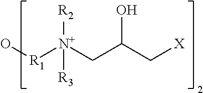

where R₁ is, independently at each instance, a C1-C6 alkyl; R₂ and R₃ are, independently at each instance, a C1-C6 alkyl or substituted C1-C6 alkyl, and X is, independently at each instance, a halogen; and one or more cationic dyes.

### DETAILED DESCRIPTION

Embodiments relate to dyeing formulations containing dye carrier compositions and methods of dyeing of aramid fibers and articles, particularly meta-aramids. Dye carrier compositions disclosed herein may be non-volatile, have low or negligible vapor pressure at room temperature, and correspondingly negligible VOC emissions, and include one or more ionic liquids and/or bis-quaternary amine salts. Methods of dying aramid fibers and articles may include contacting the fiber or article with a dye formulation containing one or more dye carriers.

As used herein, “aramid” is meant an aromatic polyamide having at least 85% of the amide linkages formed between aromatic rings, particularly aromatic polyamides such as poly-meta-phenylene isophthalamide and poly-para-phenylene terephthalamide. Aramids may include commercially available materials formed by the reaction of meta-phenylenediamine and isophthaloyl chloride, such as NOMEX™ and CONEX™ produced by DuPont and Teijin, respectively.

Dye formulations may include one or more among each of cationic dyes, solvents, dye carriers, and various additives. Cationic dyes include any suitable dye for application to aramids including phenoxazinium dyes such as phenoxazin-5-ium, 3,7-bis(diethylamino)-chloride, azo dyes, triarylmethane dyes, anthraquinone dyes, azamethine dyes, triazoleazo dyes, thiazoleazo dyes, benzothiazoleazo dyes, triphenylmethane dyes, and the like. Solvents used in dye formulations include aqueous fluids, salt or brine solutions, buffers, alcohol-water mixtures, and the like. Dye formulations may include one or more cationic dyes at any suitable concentration, such as at a percent by weight (wt %) in the range of 1 wt % to 10 wt %, 2 wt % to 10 wt %, or 2 wt % to 8 wt %.

Dye formulations disclosed herein may include one or more dye carriers such as dialkyl imidazolium salts or bis-quaternary ammonium salts. Dialkyl imidazolium salts may include salts having a cation of the general formula:

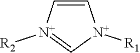

where R₁ and R₂ are, independently, selected from C1 to C8 alkyl. Imidazolium salts disclosed herein may include 1,3 dialkyl imidazolium salts, having a dialkyl imidazolium cation such as 1,3-dimethylimidazolium, 1-ethyl-3-methylimidazolium, 1-butyl-3-methylimidazolium, 1-butyl-2,3 dimethyl imidazolium, 1-ethyl-3-methylimidazolium, 1-octyl-3-methylimidazolium salt, 1-ethyl-3-methylimidazolium, 1-butyl-3-methylimidazolium, 1-octyl-3-methyl-imidazolium, 1-allyl-3-methylimidazolium, and the like. The anion component of the imidazolium salt may be a halide, such as chloride, bromide, iodide, and the like, or a C1 to C6 carboxylate, such as formate, acetate, propionate, and the like. Examples of dialkyl imidazolium salts include 1-ethyl-3-methylimidazolium acetate, 1-ethyl-3-methylimidazolium propionate, 1-methyl-3-methylimidazolium formate, and 1-propyl-3-methylimidazolium formate, and 1-allyl-3-methylimidazolium chloride, and the like.

Dye carriers may include bis-quaternary amine salts having a cation of the formula:

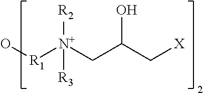

where R₁ is, independently at each instance, a C1-C6 alkyl; R; and Ra are, independently at each instance, a C1-C6 alkyl or substituted C1-C6 alkyl, and X is, independently at each instance, a halogen such as Cl, Br, or I. Suitable bis-quaternary salts include, for example, N,N″-(oxybis(ethane-2,1-dyil)-bis(3-chloro-2-hydroxy-N,N-dimethylpropan-1-aminium) chloride.

Dye formulations may include one or more dye carriers at a percent by weight (wt %) in a range of 1 wt % to 10 wt %, 2 wt % to 8 wt %, or 2 wt % to 6 wt % by weight. One or more dye carriers may also be combined with 1-phenoxy-2-propanol (PPh) at a percent by weight (wt %) ranging from 1 wt % to 10 wt %, 2 wt % to 8 wt %, or 2 wt % to 5 wt %, or a weight ratio of 2:1 to 1:2, or 1.5:1 to 1:1.5. Dye formulations may have a pH in a range of pH 5 to pH 13, pH 6 to pH 12.5, or pH 6.5 to pH 12. When dye formulations include PPh, the pH may be lower, such as in the range of pH 2.5 to pH 5, pH 2.5 to pH 4, or pH 3 to pH 4. In an example, dye formulations may include one or more dye carriers at 3 wt % to 6 wt %, PPh at 0 wt % to 6 wt %, and a pH ranging from 2.5 to 12.5.

Dye formulations may include one or more additives such as materials for pH adjustment, including organic acids, mineral acids, inorganic salts such a sodium nitrate or sodium chloride, emulsifiers, surfactants such as anionic surfactants, UV light absorbers, pH adjusters such as buffers, acids, or bases, processing aids, and the like.

Methods of applying dyes to an aramid fiber may include preparing a dye solution with dye carrier, quantifying and adjusting the pH, contacting the aramid fiber sample with the dye solution, dyeing the aramid fibers at a selected temperature, rinsing excess dye from the dyed aramid fiber, and drying the fiber sample.

During application of the dye formulation (e.g., when contacting the aramid fiber or article) the temperature of the mixture may be in the range of 120° C. to 170° C., 130° C. to 160° C., or 130° C. to 150° C. Contact may occur in any suitable dyeing equipment, including pressurized or non-pressurized vessels. In some cases, aramid fibers and articles may be wound through an internal rotating assembly and circulated through the dye formulation during the dyeing operation. Dyeing times may vary depending on a number of factors such as sample size, temperature, dye or dye carrier concentration, and the like, but generally may vary from 30 minutes to an hour or more. Color values may be quantified using a Hunterlab™ colorimeter, including L, A, and B color values.

### EXAMPLES

The following examples are provided to illustrate the embodiments of the invention, but are not intended to limit the scope thereof. Table 1 provides the materials used in the following example.

TABLE 1
Materials used in the example

| | |
|---|---|
| Aramid | Nomex ® 462 from DuPont composed of 93% poly-meta- |
| | phenyleneisophthalamide, 5% poly-para-phenylene- |
| | terephthalamide, and 2% P140 carbon fiber |
| PPh | 1-Phenoxy-2-propanol |
| Dialkyl | 1-Ethyl-3-methylimidazolium acetate |
| imidazolium | |
| salt | |
| Bis- | 50% aqueous solution of N, N″-(oxybis(ethane-2, |
| quaternary | 1-dyil)bis(3-chloro-2-hydroxy-N, N-dimethylpropan- |
| amine | aminium) chloride |
| Dye | Basic Blue #3 cationic dye (CAS: 33203-82-6) |
| Acid | HPLC grade glacial acetic acid |
| Base | 0.02N Sodium Hydroxide |

### Example 1: Dyeing Process for Aramid Fabric

In this example, aramid fabric samples were assayed using various dye formulations. A 2 wt % solution of Basic Blue #3 was prepared by dissolving 2 g of dye in 98 g of deionized water.

### Dyeing Equipment and Loading Procedure

Dyeing was performed in an Ahiba™ IR Pro Exhaust Dyeing chamber from Datacolor. The chamber accommodated up to 15 stainless steel, 250 mL dyeing vessels in a rotating assembly, and was capable of operating at up to 130° C.

Samples were prepared with 2″×2″ Nomex® swatches and placed inside a numbered dyeing vessel. The vessels were charged with 2.5 g of the aqueous blue dye solution, followed by the desired weights of the various individual components of the test dye bath (e.g., dye carriers and water), and adjusted to 50.0 g with water. The pH of each bath was adjusted with acid or base as required. The dyeing vessels were then sealed and placed in a numbered holder of the rotating assembly. The Ahiba™ IR chamber was then heated at the desired temperature for 50 minutes. Following dye formulation treatment, the samples were cooled and washed with water to remove excess dye. The rinsed swatches were dried in a 45° C. oven.

The L and b color values of the swatches were then measured with a Hunterlab™ colorimeter. The colorimeter was calibrated with a D65-10 Diffuse 8° white tile provided by the manufacturer. As a control sample, an undyed swatch of NOMEX™ was placed in the center of a 4.25×4.25 inches black ceramic tile equipped with a mask designed to help position and hold the swatch on the tile. Several readings were taken and the results averaged. The undyed swatch was replaced with one of the dyed swatches so that color reading could be taken. This procedure was repeated with all the swatches. Sample formulations and color results are shown in Table 2.

TABLE 2
Dye formulations and process results

| | | | Bis- | | | | |
|---|---|---|---|---|---|---|---|
| | | | quater- | | | | |
| | | Dialkyl | nary | | | | |
| Sam- | PPh | Imidazolium | Amine | Temp. | | | |
| ple | (wt %) | salt(wt %) | (wt %) | (° C.) | pH | L | B |
| Nomex | — | — | — | — | — | 87.6 | 11.9 |
| B1 | — | — | — | 70 | 3.5 | 67.5 | −9.4 |
| CS1 | 2 | — | — | 70 | 3.5 | 60.6 | −13.4 |
| IS1 | — | 2 | — | 70 | 3.5 | 67.8 | −9.0 |
| 2 | — | — | 2 | 70 | 3.5 | 65.4 | −11.0 |
| CS2 | 4 | — | — | 70 | 3.5 | 61.7 | −12.8 |
| IS3 | — | 4 | — | 70 | 3.5 | 70.1 | −7.3 |
| IS4 | — | — | 4 | 70 | 3.5 | 64.5 | −11.4 |
| B2 | — | — | — | 130 | 3.5 | 64.3 | −8.9 |
| CS3 | 3 | — | — | 130 | 3.5 | 55.9 | −15.0 |
| CS4 | 4 | — | — | 130 | 3.5 | 41.2 | −17.1 |
| IS5 | — | 4 | — | 130 | 3.5 | 62.2 | −10.2 |
| IS6 | — | — | 4 | 130 | 3.5 | 58.4 | −13.9 |
| IS7 | 2 | 2 | — | 130 | 3.5 | 55.0 | −14.1 |
| IS8 | 2 | — | 2 | 130 | 3.5 | 39.7 | −16.7 |
| IS9 | — | 2 | 2 | 130 | 3.5 | 57.7 | −12.9 |
| B3 | — | — | — | 130 | 6.8 | 50.8 | −16.4 |
| CS5 | 3 | — | — | 130 | 6.7 | 51.2 | −16.8 |
| CS6 | 4 | — | — | 130 | 6.4 | 41.3 | −14.9 |
| IS10 | — | 3 | — | 130 | 6.5 | 43.4 | −11.4 |
| IS11 | — | 4 | — | 130 | 6.2 | 46.2 | −12.0 |
| IS12 | — | 6 | — | 130 | 6.5 | 45.5 | −9.9 |
| IS13 | — | 4 | — | 130 | 12.5 | 46.6 | −14.1 |
| IS14 | — | — | 4 | 130 | 9.6 | 54.3 | −14.6 |
| IS15 | — | — | 4 | 130 | 6.7 | 57.2 | −13.9 |
| IS16 | — | — | 6 | 130 | 6.7 | 29.3 | −19.7 |

Samples in the chart are denoted as “Nomex” for the control sample without exposure to dye solution, “B” for blank samples including a solution of dye and water without dye carrier, “CS” for comparative samples containing PPh alone, or “IS” for inventive samples containing a dialkyl imidazolium or bis-quaternary amine dye carrier alone or combined with PPh. Target performance values for samples are minimum values of L or b with respect to Nomex and blank samples.

Samples were assayed at pH ranging from lower pH (3.5, a typical dye pH for PPh) and higher pH (˜6.7-12.5), and at low (70° C.) and high dyeing temperature (130° C.). Inventive samples typically performed as well or better than the comparative formulations containing PPh alone. Example 1 indicates that the inventive dye formulations (IS) have been found to generally outperform PPh at higher pHs (6-12). Notably, combining 2% by weight PPh and 2% by weight bis-quaternary amine salt (IS8) resulted an L value of 39.7 and a b value of −16.7, outperforming CS4 including 4 wt % PPh. In contrast, L values of 43.4 to 46.2 were achieved by adding 3, 4, or 6 wt % dialkyl imidazolium salt to the dye bath in the pH range of 6.2 to 6.5 (IS10-IS12). In addition, an L value of 46.6 was obtained with 4% dialkyl imidazolium salt at a pH of 12.5 (IS13, b value of −14.1). Addition of 4 wt % bis-quaternary amine salt to the dye bath at pH values of 9.6 (IS14) or 6.7 (IS15) produced L values of ˜55, while increasing to 6 wt % resulted in an L value of 29.3 and a b value of −19.7 (IS16).

While the foregoing is directed to exemplary embodiments, other and further embodiments may be devised without departing from the basic scope thereof, and the scope thereof is determined by the claims that follow.

1. A composition for dyeing aramids, comprising:
one or more dye carriers selected from
dialkyl imidazolium salts having a cation of the general formula: 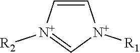
where R₁ and R₂ are, independently, selected from C1 to C8 alkyl, and bis-quaternary amine salts having a cation of the formula: 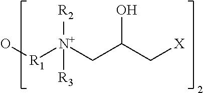
where R₁ is, independently at each instance, a C1-C6 alkyl; R₂ and R₃ are, independently at each instance, a C1-C6 alkyl or substituted C1-C6 alkyl, and X is, independently at each instance, a halogen; and
one or more cationic dyes.

2. The composition of claim 1, wherein one or more dye carriers are present at a percent by weight ranging from 3 wt % to 6 wt %.

3. The composition of claim 1, wherein the composition comprises a pH in a range of pH 6 to pH 12.5.

4. The composition of claim 1, wherein the composition further comprises 1-phenoxy-2-propanol at a percent by weight of 2 wt % to 6 wt %.

5. The composition of claim 4, wherein the pH is in a range of pH 2.5 and pH 4.

6. The composition of claim 1, wherein the one or more dye carriers comprise a bis-quaternary amine salt at a percent by weight of the composition (wt %) in a range of 2 wt % to 6 wt % and the composition has a pH of 6 to 7.

7. A method, comprising:
contacting an aramid with a dye formulation at a temperature in a range of 120° C. to 160° C., the dye formulation comprising:
one or more dye carriers selected from
dialkyl imidazolium salts having a cation of the general formula: 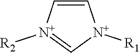
where R₁ and R₂ are, independently, selected from C1 to C8 alkyl, and bis-quaternary amine salts having a cation of the formula: 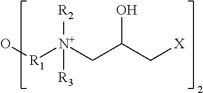
where R₁ is, independently at each instance, a C1-C6 alkyl; R₂ and R₃ are, independently at each instance, a C1-C6 alkyl or substituted C1-C6 alkyl, and X is, independently at each instance, a halogen; and
one or more cationic dyes.

8. The method of claim 7, wherein the temperature is in a range of 130° C. to 140° C.
